(19) United States
(12) Patent Application Publication
(10) Pub. No.: US 2007/0188455 A1
(43) Pub. Date: Aug. 16, 2007

(54) Single element digital and analog input for a control device

(75) Inventors: Neil O'Connell, Cork City (IE); Damien O'Sullivan, Grange (IE); Denis O'Keeffe, (US); Erik Charlton, Atherton, CA (US); Eugene Canavan, Bray (IE)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Logitech Europe S.A., Romanel-sur-Morges (CH)

(21) Appl. No.: 11/355,906

(22) Filed: Feb. 15, 2006

(51) Int. Cl. G09G 5/08

(52) U.S. Cl. 345/163

(57) ABSTRACT

A input element which moves in two directions to activate a digital on/off switch in each direction. In addition, moving beyond a certain point will activate an analog input. The on/off switch activates a function, while the analog input varies the amount of the function in the direction activated. In one embodiment, the function is a zoom or scroll function. In one embodiment, the input element is a jog dial that pivots and is located on the side of a mouse where it can be activated by a user's thumb.

### CROSS-REFERENCES TO RELATED APPLICATIONS

This application is related to application Ser. No. 10/857,674, filed May 28, 2004, entitled “Roller with Multiple Force Sense Levels.”

### BACKGROUND OF THE INVENTION

The present invention relates to a combined digital and analog input for a control device, and in particular to a thumb actuated jog dial on a mouse.

A switch or dial on the side of a mouse that can be activated by a thumb has been described in many different designs. U.S. Pat. No. 4,891,632 shows a track ball that can be manipulated by a user's thumb. Microsoft U.S. Pat. No. 5,473,344 shows a thumb wheel which is an elongated roller that can be depressed by pivoting around one end for a clicking switch. U.S. Pat. No. 5,712,725 shows a mouse with a side, thumb actuated rotational transducer for controlling microscope focus. The transducer generates a pulse train proportional to the rotational angle.

Primax U.S. Pat. No. 5,771,038 shows a number of different thumb actuated switches for the side of a mouse, including a ball, a microstick and a dial. The dial using two tuning disks with variable capacitance. Primax U.S. Pat. No. 5,917,473 shows a mouse with a side, thumb actuated dial which encodes using electrical brushes. The dial can be depressed for a click switch function. IBM U.S. Pat. No. 6,115,029 shows a side thumb dial on a mouse.

Alps U.S. Pat. No. 6,525,713 shows, as prior art, a mouse with an automatic return sliding switch between the buttons on the top of a mouse. This patent goes on to show a jog/shuttle switch on the front and side of a mouse. These switches are wheels, located on top of each other, with a jog switch providing continuous pulses in accordance with rotation of the jog dial, while a shuttle switch provides pulses corresponding to the rotational angle and direction.

Armstrong U.S. Pat. No. 6,198,473 shows forward and backward pressure sensitive buttons on the side of a mouse in FIG. 32, with varied speeds of video frame rates depending on the amount of pressure applied. Primax U.S. Pat. No. 5,883,619 shows a rounded control button which can be tilted in x-y directions to produce scrolling. The '619 patent also shows a bidirectional thumb button on the side of a mouse for controlling zoom.

The above related application “Roller with Multiple Force Sense Levels” shows a roller which can pivot with two levels of force activating two stage buttons or pressure sensitive buttons. Logitech U.S. Pat. No. 6,879,316 shows a scroll wheel with pressure sensitive buttons on either side for activating continuous scrolling.

### BRIEF SUMMARY OF THE INVENTION

The present invention provides an input element which moves in two directions to activate a digital on/off switch in each direction. In addition, moving beyond a certain point will activate an analog input. The on/off switch activates a function, while the analog input varies the amount of the function in the direction activated. In one embodiment, the function is a zoom or scroll function. In one embodiment, the input element is a jog dial that pivots and is located on the side of a mouse where it can be activated by a user's thumb.

In one embodiment, the job dial pivots a limited angle, such as less than 20 degrees. The analog inputs are pressure sensors on either side of the jog dial. A spring return system brings the jog dial back to a neutral position after a user finger or thumb is removed. The analog switches are activated before the digital switch, with the user feeling the click of the digital switch as feedback. However, the output of the analog switch is not used for control until the digital switch is activated.

In one embodiment, the input is a jog dial. A slider or other device may also be used. The input device is a single piece contacted by the user, which activates both the analog and digital switches without the user having to contact a second input device or button.

### BRIEF DESCRIPTION OF THE DRAWINGS

FIG. 1 is a block diagram illustrating the electronics in a mouse according to an embodiment of the present invention.

FIG. 2 is a diagram illustrating the software in a mouse and associated computer according to an embodiment of the present invention.

FIG. 3 is a side view of a mouse showing a jog dial according to an embodiment of the present invention.

FIG. 4 is a cut-away view of a portion of a mouse according to an embodiment of the invention, showing jog dial and a printed circuit board (PCB) inside the mouse.

FIG. 5 is a diagram of the backside of the PCB of FIG. 4 illustrating the digital switch.

FIG. 6 is a diagram of an example of the analog and digital switch activation angles.

### DETAILED DESCRIPTION OF THE INVENTION

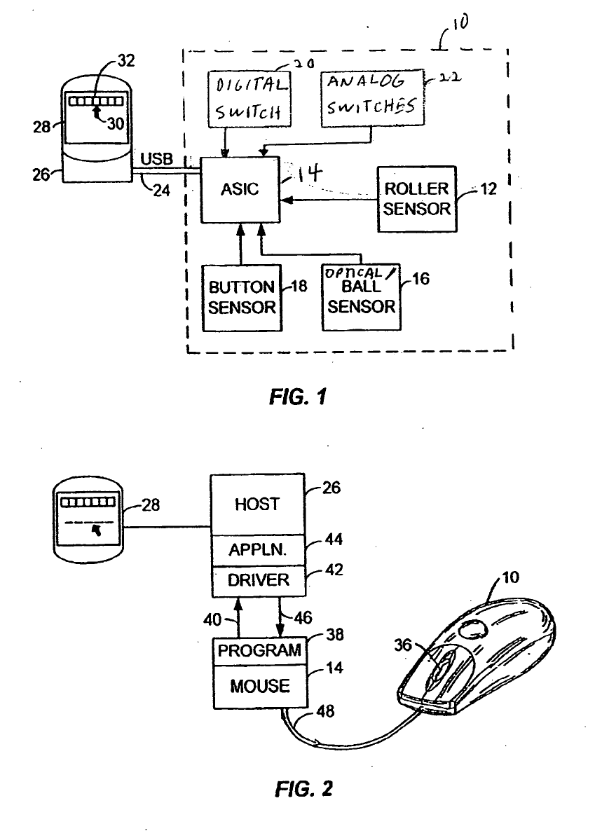

FIG. 1 is a block diagram of an electronic system for one embodiment of the invention. Shown is a mouse 10 which has a roller sensor 12 for detecting the movement of a roller or wheel. Alternately, a different input device 10 could be used, such as a keyboard, remote control, gamepad, joystick, etc. The sensor signals are provided to a processing circuit in an ASIC 14. ASIC 14 also receives signals from a mouse movement sensor 16 (e.g., ball or optical) and button sensors 18. Mouse sensor 16 provides detector signals from two encoder rollers on a mouse ball, or alternately an optical signal on an optical mouse. Also shown are inputs to the ASIC from a digital switch 20 and analog switches 22.

FIG. 2 is a block diagram of the software used in an embodiment of the present invention. Shown is a mouse 10 with a roller 36. Inside mouse 10 is a processor or ASIC 14 including a program 38 for controlling the mouse. Sensor signals 40 are provided to host computer 26, in particular to a driver 42 in the host. The driver in turn can provide signals to an application program 44, which controls the particular graphics on a display 28. Feedback signals 46 can be provided to the mouse. A wired or wireless connection may be used.

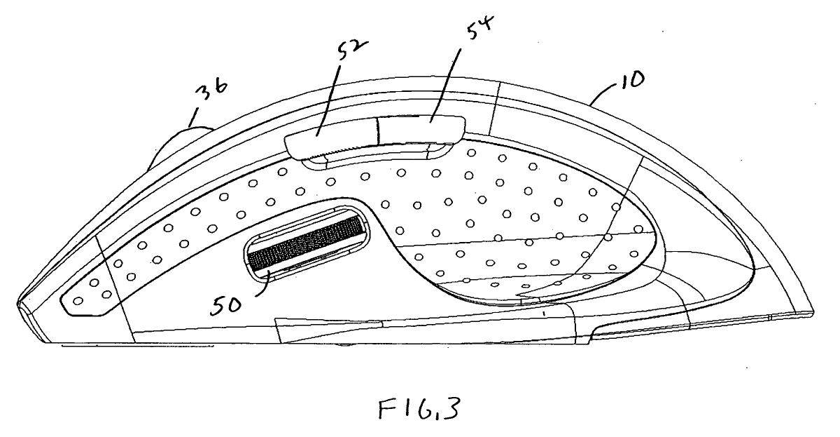

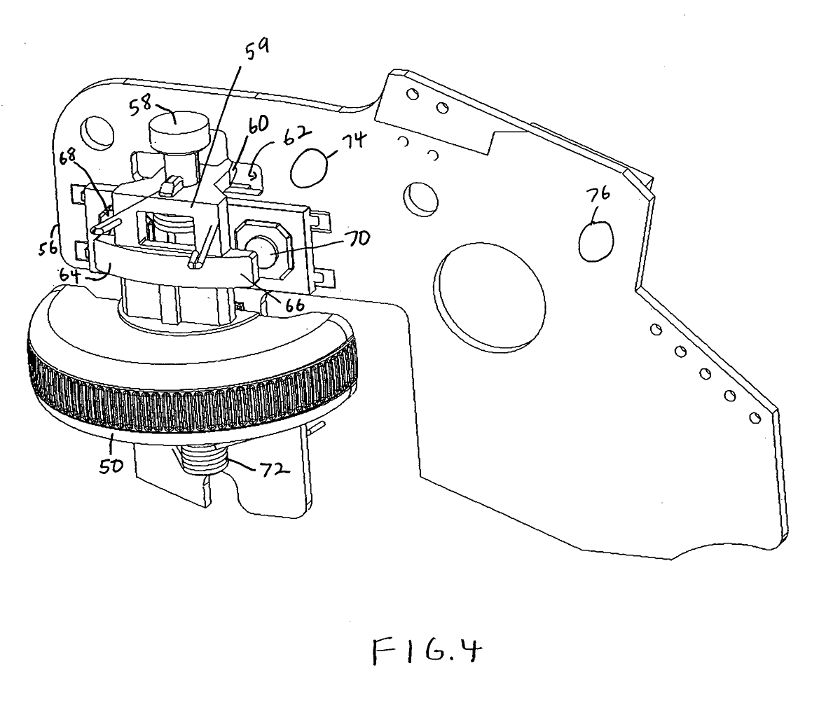

FIG. 3 is a side view of mouse 10 showing a roller 36 on top, and a jog dial 50 on the side where it can be reached by a user's thumb. Also shown are a pair of side buttons 52 and 54.

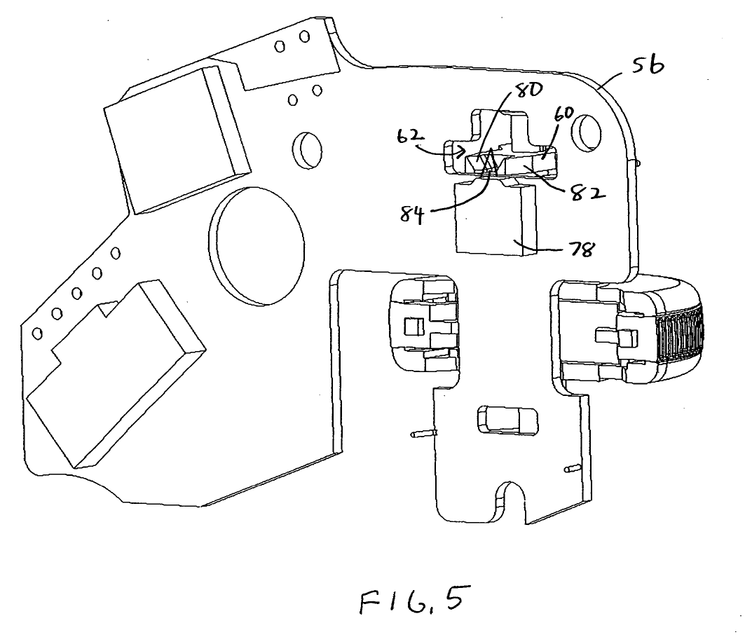

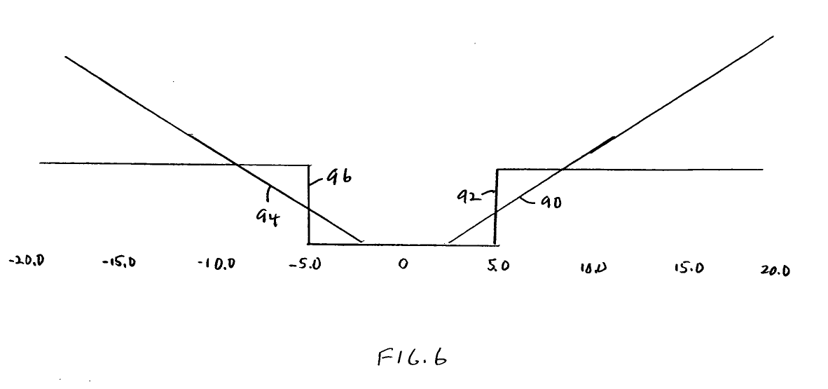

FIG. 4 is a cut-away view of a portion of mouse 10, showing jog dial 50 and a printed circuit board (PCB) 56 inside the mouse. Jog dial 50 can rotate up to 20 degrees around an axle 58. Axle 58 is connected to the jog dial 50 through a body 59. The rotation will activate a digital switch on the other side of the PCB (visible in FIG. 5) by the movement of a member 60 extending through a slot 62 in PCB 56.

When jog dial 50 is rotated, extending arms 64 and 66 contact and apply pressure to pressure sensitive buttons 68 and 70, respectively. Buttons 68 and 70 may alternatively be single stage digital button, having on and off singles. A spring 72 returns the jog dial to the center position when the user's thumb is removed. A pair of switches 74 and 76 are activated by buttons 52 and 54 of FIG. 3. Hidden from view behind body 59 supporting jog dial 50 is a switch which is activated when the jog dial is depressed for a clicking function. The body and jog dial are biased outward by either the switch itself, spring 72, or a separate spring.

FIG. 5 shows the backside of PCB 56. Member 60, connected to the jog dial, extends through slot 62 above a digital switch 78. Alternatively, switch 78 may be an analog switch, such as a pressure sensitive switch. Two protrusions 80 and 82 move an element 84 extending from switch 78 left or right, depending on the direction of movement of the jog dial. This in turn provides a positive or negative digital signal from switch 78, showing that it has been activated, and the direction of activation.

FIG. 6 illustrates the switch activation by the jog dial. The spring causes the jog dial to normally be at the 0 position. Upon thumb movement of the jog dial in the positive direction, a first analog switch is activated at an angle of about 3 degrees, with increasing pressure providing higher analog outputs as indicated by line. However, the ASIC does not report out this signal until the digital switch is activated, at about 5 degrees in this example. From 5 degrees onward, the digital switch stays activated in the on position, while the pressure on the analog switch increases as more force is applied by the thumb, with the analog signal increasing as shown. Similarly, in the negative direction, a line 94 illustrates the analog switch output and a line 96 indicates the activation of the digital switch.

The jog wheel is provided with driver software that alters its function depending on the user application. In one embodiment, the jog wheel could be used instead of a scrolling wheel to control the following functions in the following applications:

Page Navigation (Web, Word, PDF)—page up/down.

Cell Navigation (Email, Shell, Excel, Messenger)—arrow up/down

Miscellaneous

Photo—zoom in/out

Music—previous/next

The input provided could also be any number of other functions. For example, volume could be controlled by the amount of rotation. In one embodiment, volume could be controlled in one direction while song scrolling/selection could be controlled in the other analog direction. The two analog sensor could be mounted so that the jog dial at 0 degrees is at a mid-point of each buttons pressure curve. Thus, the user would feel some resistance in both directions, upon activation and release, such as for turning volume up and down in one direction. In another embodiment, there is no tactile feedback from the analog sensors/switches, only from the digital sensor/switch.

In one embodiment, a rotary encoder could be used to provide a pulse train, with the number of pulses corresponding to the angle of turning. In addition, a single ratchet type “click” feedback to the user could be provided after a certain angle, simulating a digital switch click, with the digital signal being replaced by that number of initial pulses in either direction. In one embodiment, the analog switch is a potentiometer.

In one embodiment, minimal movement is required, with the analog signal instead corresponding to the amount of force or pressure applied. Where little or no movement is required, the force or pressure sensor could provide both the analog and digital inputs. The digital on signal could be triggered at some amount of force, for example between 10-100 grams, with force beyond that point providing the analog signal.

In other embodiments, the input element is not a jog wheel. A slider can be used, with some defined amount of movement activating the digital on function. Alternately a mini-joystick could be used. These elements could have any number of devices to provide the user feedback “click” feel at the digital on point. Various pressure or force sensors could be used, such as conductive rubber pressure sensors or dome sensors.

In one embodiment, two stage buttons could be used, as described in the related application referenced above and hereby incorporated herein by reference. The second stage of the two stage switch could provide an accelerated version of the function selected by the first digital input. Also, an analog input could be used in conjunction with a two stage digital input. The first digital input would activate the function, while the second digital input could either step up the value or acceleration of the function, or could vary the function.

As will be understood by those of skill in the art, the present invention may be embodied in other specific forms without departing from the essential characteristics thereof. For example, the input device could be put on a PDA, a music player, a keyboard, a remote control or the like. The input element could be designed to be activated by a digit other than the thumb. The jog dial embodiment could be pivoted up to 30 or 40 degrees. The jog dial and PCB could be a symmetrical piece that can be removed and plugged into the other side of the mouse, replacing a plain panel on that side, to allow configuring the mouse for right and left hand users. In one embodiment, rather than an analog signal, a stepped digital signal or pulse train can be provided. Accordingly, the foregoing description is intended to be illustrative, but not limiting, of the scope of the invention which is set forth in the following claims.

What is claimed is:

1. An input device comprising:
a housing;
an input element extending from said housing;
analog sensor activated by movement of said input element in first and second directions; and
digital input sensors activated by movement of said input element in first and second directions.

2. The input device of claim 1 wherein said device is a mouse, and said input element is mounted on a side of said mouse for activation by a user's thumb.

3. The input device of claim 1 wherein said input element is a dial.

4. The input device of claim 1 wherein said input element is a slider.

5. The input device of claim 1 wherein said analog sensor is first and second pressure sensors.

6. The input device of claim 1 wherein said analog sensor is a rotational sensor.

7. The input device of claim 1 wherein said digital input activates a zoom function, and said analog input controls an amount of said zoom.

8. The input device of claim 1 wherein said digital input activates a scrolling function, and said analog input controls an amount of said scrolling.

9. The input device of claim 1 wherein said digital input activates a media selection function, and said analog input controls scrolling through a list of said media.

10. A mouse comprising:
a housing;
a jog dial extending from a side of said housing and mounted to allow pivoting up to no more than 30 degrees and activation by a user's thumb;
an analog sensor activated by pivoting of said jog dial in first and second directions; and
a digital input sensor activated by movement of said input element in first and second directions.

11. A method for providing signals from an input device comprising:
applying force to a single input element on said input device;
providing a variable signal proportional to the amount and direction of said force; and
providing a digital signal upon reaching a threshold in each of first and second directions.

12. The method of claim 11 wherein said digital signal is provided upon a predefined amount of movement of said input element.

13. The method of claim 11 wherein said digital signal activates a zoom function, and said variable signal controls an amount of said zoom.

14. The method of claim 11 wherein said digital signal activates a scrolling function, and said variable signal controls an amount of said scrolling.

15. The method of claim 11 wherein said digital signal activates a media selection function, and said analog signal controls scrolling through a list of said media.

16. An input device comprising:
a housing;
an input element extending from said housing;
first digital sensor activated by movement of said input element in first and second directions; and
second digital input sensors activated by movement of said input element in first and second directions.

17. The input device of claim 1 wherein said device is a mouse, and said input element is mounted on a side of said mouse for activation by a user's thumb.

18. The input device of claim 1 wherein said input element is a dial.

19. The input device of claim 1 wherein said input element is a slider.

20. The input device of claim 1 wherein said analog sensor is first and second pressure sensors.

21. The input device of claim 1 wherein said analog sensor is a rotational sensor.

22. The input device of claim 1 wherein said digital input activates a zoom function, and said analog input controls an amount of said zoom.

23. The input device of claim 1 wherein said digital input activates a scrolling function, and said analog input controls an amount of said scrolling.

24. The input device of claim 1 wherein said digital input activates a media selection function, and said analog input controls scrolling through a list of said media.
